(19) United States
(12) Patent Application Publication
(10) Pub. No.: US 2003/0038089 A1
(43) Pub. Date: Feb. 27, 2003

(54) Method of reducing contaminants in drinking water

(76) Inventor: Ehud Levy, Roswell, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/256,177

(22) Filed: Sep. 26, 2002

Related U.S. Application Data
(63) Continuation of application No. 09/560,824, filed on Apr. 28, 2000, now abandoned.
Application No. 09/560,824 is a continuation-in-part of application No. 08/819,999, filed on Mar. 18, 1997, now Pat. No. 6,241,893.
Application No. 08/819,999 is a continuation-in-part of application No. 08/599,925, filed on Feb. 12, 1996, now Pat. No. 5,616,243.
Application No. 08/599,925 is a continuation-in-part of application No. 08/478,863, filed on Jun. 7, 1995, now Pat. No. 5,612,522.
Application No. 08/478,863 is a continuation-in-part of application No. 08/261,998, filed on Jun. 17, 1994, now Pat. No. 5,538,746.

(51) Int. Cl. C02F 1/00

(52) U.S. Cl. 210/767

(57) ABSTRACT

This invention provides a method making water safer for use by humans and animals by reducing the levels of a number of different contaminants present in the water, by contacting the water with a first purification medium comprising alumina; and contacting the water with a second purification medium comprising zirconia.

This application is a continuation-in-part of U.S. Ser. No. 08/819,999, filed Mar. 18, 1997, the entire contents of which are hereby incorporated by reference.

### BACKGROUND OF THE INVENTION

1. Field of the Invention

The invention relates to methods for water filtration using a combination of filtration media. More particularly, the invention relates to methods for water filtration wherein the water passes through filtration media containing alumina and through a filtration media containing zirconia.

2. Description of Related Art

The chemistry of potable drinking water varies significantly from location to location throughout the United States. Many municipal drinking water plants are delivering drinking water from wells and ground water that contains arsenic, lead, VOC (Volatile Organic Chemicals) such as chloroform, mercury and other contaminants. Arsenic and VOC have also been found in drinking water in many other countries. Arsenic species are being used or have been used in the manufacture of medicine and cosmetics among other things, and have been used as agricultural insecticides. They have also been used as desiccants, in rodenticides and in herbicides. Arsenic contaminants are primarily found as an arsenate or an arsenite in drinking water. Chloroform, as a member of the trihalomethanes family, is often a major byproduct of chlorination-disinfection processes used in water treatment. These contaminants are considered health hazards which can cause cancer, skin discoloration, liver disease and a host of other health problems.

To reduce arsenic from drinking water, municipal water plants use different techniques such as redux, adsorption and precipitation. The most common media for adsorption used today is alumina or weak acid ion exchange resins. Alumina works well to reduce arsenic levels from about one part per million to about five parts per billion. However, alumina media for such purposes is usually used in small applications such as point-of-use water filters, and such use is limited. This is due primarily to the poor kinetics of such filters. Ion exchange resins suffer the same limitation. Another technique employed to remove arsenic is reverse osmosis which is very effective. However, it is an expensive treatment which causes a considerable amount of water to be wasted. In some cases this technique has experienced difficulty due to a change in the oxidation state of the arsenic contaminate from an arsenate to an arsenite. Municipalities have been struggling for a number of years, using different techniques of oxidizing arsenic for removal by their water plants. The cost for doing so in capital investment is extremely high and at present over six hundred municipalities continue to experience substantial difficulty in their efforts to reduce arsenic content from drinking water. The cost of doing so is for many small municipalities, prohibitive due to the complexity of existing methods which are adapted from large scale plants. Moreover, many proposed treatments adversely affect the taste and color of the water and may produce unknown byproducts.

### SUMMARY OF THE INVENTION

This invention provides a method making water safer for use by humans and animals by reducing the levels of a number of different contaminants present in the water, by contacting the water with a first purification medium comprising alumina; and contacting the water with a second purification medium comprising zirconia. Treatment in this manner can reduce the levels of heavy metals in the water, in particular arsenic levels, by amounts ranging from about 20% to about 100%, without any concomitant modification or degradation of the water pH or water hardness. In addition, the treatment method of the invention can reduce the levels of volatile organic compounds, such as chloroform, and can provide large scale reductions in the level of bacterial contamination, particularly contamination by coliform and pseudomonal bacteria.

### DETAILED DESCRIPTION OF SPECIFIC EMBODIMENTS OF THE INVENTION

The first purification medium used in the method of the invention contains alumina. Acid-washed alumina has been found to be suitable in this regard, and is described in U.S. Pat. No. 5,133,871, issued Jul. 28, 1992, the entire contents of which are hereby incorporated by reference. In particular, acid-washed alumina having particle sizes of about 28 to about 48 mesh (and may have an average particle size in this range) and BET surface area of about 160 to about 260 m²/g has been found to be suitable as the first purification medium containing alumina.

The second purification material contains zirconia. Suitable zirconia-containing purification materials include those disclosed in U.S. Serial No. 08/819,999, filed Mar. 18, 1997, the entire contents of which are hereby incorporated by reference. The zirconia may be in powdered form, or in granular form. If in powdered form, the zirconia typically has a particle size distribution ranging from about 5 to about 100 micron, more particularly from about 10 to about 60 micron, and typically has a mean particle size of about 40 micron or larger, more particularly about 60 micron.

In larger scale systems, granular zirconia may be more desirable. In these situations, the zirconia is generally of a particle size of about 20 to about 100 mesh.

The zirconia used in the second purification medium desirably has pore sizes ranging from about 5 Angstroms to about 500 Angstroms, more particularly, from about 5 Angstroms to about 60 Angstroms for particularly efficient arsenic removal. The BET pore volume of the zirconia typically ranges from about 300 cm³/g to about 800 cm³/g, more particularly from about 300 cm³/g to about 600 cm³/g. Zirconia having large pores (e.g., over 60 Angstrom) have been found to lose their removal capacity for arsenic by about 60%. Those of skill in the art will recognize that the pore size may be varied within the above-desired ranges, or even outside of it, in order to optimize removal efficiency for the heavy metal of interest.

The zirconia may desirably be formed into a cartridge containing other components, such as activated carbon, or other adsorbents, as well as an optional binder. While the relative amounts of each component in the cartridge are substantially variable, one suitable composition contains, by weight, based on the total weight of cartridge adsorbent, about 5% to about 15% zirconia, about 70 % activated carbon, and about 15% to about 25% organic binder. The powder is heated for 30-60 minutes and then compressed for 15 minutes at 60-100 psi.

In use, the method of the invention simply involves passing the water to be treated through the alumina containing purification medium and then through the zirconia containing purification medium. If the purification medium is in the form of cartridges, the cartridges may be of any suitable shape generally adapted or used in water purification. Examples include cylindrical or toroidally shaped cartridges. Generally the cartridges are disposed near or contain one or more inlets and/or outlets for the water, which is caused to flow over and/or through the cartridge material. The alumina containing purification material may be disposed adjacent to the zirconia containing purification material (e.g., in the same or an adjacent cartridge), or in a separate vessel, connected so that water leaving the alumina containing purification material flows over and/or through the zirconia containing purification material.

The invention can be more fully understood by reference to the following nonlimiting examples of particular embodiments thereof.

### EXAMPLES

### Example 1

Reduction of Arsenic

Tap water (Suwanee, Ga.) was contaminated with arsenic trioxide to a concentration of about 200 to about 300 ppb of arsenic. The water is passed through a first filter cartridge containing acid washed alumina. Effluent from this treatment is passed through a filter cartridge containing ultrapure zirconium, substantially free from radioactive species, organic compounds, and metal oxides.

The level of arsenic was measured by a Perkin Elmer atomic absorption spectrometer. Standard atomic absorption conditions for As was applied in the test with EDL light source. There was a linear relationship between [As] and AA absorbance in range of 5-100 part per billion. The influent was diluted to the specified concentration before the AA measurements. 20L of the solution was used to determine the As concentration.

The properties of the test water are given below. The testing was done using a test method for arsenic reduction established by ANSI/NSF-Standard 53.

| | |
|---|---|
| Alkalinity (as CaCO₃) | 100-250 ppm |
| Hardness (as CaCO₃) | 100-200 ppm |
| pH | 8.5 ± 0.25 |
| Polyphosphate (as P) | <0.5 ppm |
| Total Dissolved Solid (TDS) | 200-500 ppm |
| Temperature | 20 ± 2.5° C. |
| Turbidity | <1 NTU |
| Chlorine | <0.05 ppm |

As indicated above, the influent water had a concentration of 200-300 ppb of As. The effluent water had an As concentration under 20 ppb for 2500 gallon test. Arsenic was found to be reduced from 250 ppb to ˜2 ppb and the average reduction percentage is 99.2%. The following table summarizes the results:

| | Amount of | Capacity | As Reduction |
|---|---|---|---|
| Flow Rate | media | (gallons) | % |
| 1 GPH (gallon per hour) | 20-30 CI | 1,000 | 99.0 |
| gravity filter | (cubic inch) | | |
| 0.5-5 GPM gallon | 39-250 CI | 3,000-15,000 | 99.2 |
| per minute) | | | |
| 5-10 GPM | 250-390 CI | 25,000 | 99.8 |
| >10 GPM | >390 CI | >25,000 | 98.5 |

### Example 2

Reduction of Volatile Organic Chemicals (VOCs)

Water as described above in Example 1, but deliberately contaminated with chloroform instead of arsenic trioxide, was passed through the alumina and zirconia filter cartridges described above in Example 1. The test water had the following characteristics:

| | |
|---|---|
| Hardness (as CaCO₃) | ≦17 ppm |
| pH | 6.0 ± 0.5 |
| Total Dissolved Solid (TDS) | 20-50 ppm |
| Temperature | 21 ± 3° C. |
| Turbidity | ≦1 NTU |
| Total Organic Carbon (TOC) | ≦1 ppm |

VOC determination was carried out using a GC. The testing methodology for VOC reduction used was that specified in ANSI/NSF Standard 53-1999.

Influent water had 300 ppb of chloroform and effluent had an undetectable chloroform concentration. The average reduction percentage was 99.9%. The following table summarizes the results:

| | | | % of VOC |
|---|---|---|---|
| Flow Rate | Amount of media | Capacity (gallons) | Reduction |
| 1 GPH (gallon per | 20-30 CI | 150 | 99.8 |
| hour) gravity filter | (cubic inch) | | |
| 0.5-5 GPM (gallon | 39-250 CI | 1200-5,000 | 100 |
| per minute) | | | |
| 5-10 GPM | 250-390 CI | 5,000 | 99.9 |
| >10 GPM | >390 CI | >5,000 | 99.9 |

### Example 3

Reduction of Bacteria

Water tested for bacteria reduction had the following characteristics:

| | |
|---|---|
| Carrier Water Type | Municipal, chlorine neutralized and |
| | disinfected. |
| Water Temperature | 10-15° C. |
| Flow Rate | 0.5 GPM |
| Inlet Pressure | 50 psi |
| Challenge Organism(s) | E. Coli and P. aeruginosa |
| Target Reductions | 6 log per organism type |
| Challenge Doses | 10′ CFU/mL |
| Organism Introduction Method | Injection, positive pressure |
| QA/QC Control Samples | 2 negative control samples per organism |
| | type |
| Sample Collection Type | Spread plate/MF from composites |

The test water was seeded with challenge colonies of the indicated bacteria, and passed through a purification system containing the alumina containing purification medium and the zirconia containing purification medium described in Example 1 above. The resulting water was tested as indicated above for the presence of the indicated bacteria. Test results show the very effective removal of bacteria by the media. The percentage of the reduction is 100%. The results are given in following table:

Organism Concentration

| | | |
|---|---|---|
| Organism | Influent | Effluent |

| | | |
|---|---|---|
| E. coli | 7.5 × 10⁶ | None detected |
| P. aeruginosa | 8.6 × 10⁶ | None detected |

This large scale reduction in the numbers of microorganisms in the water was unexpected.

The use of the purification method of the invention is a substantial and unexpected advance over what has hitherto been known in the art. In particular, the use of an acid washed gamma alumina as the first purification material and zirconia as the second purification material resulted in about a 20 fold improvement in the kinetics of filtration, and about a 30 fold improvement in filtration capacity. Using these purification materials separately to treat water heavily contaminated with arsenic, it was found that alumina reduced the arsenic level from 200 ppb to 60 ppb in 200 gallons of water at a flow rate of 1 gal./min. The zirconia/carbon purification material, used alone, reduced the arsenic level from 200 ppb to 30 ppb in 300 gallons of water at the same flow rate. However, when the alumina purification material is used to treat water and followed by treatment with the zirconia purification material, the arsenic level was reduced from 200 ppb to 1 ppb for amounts of water ranging between 3,000 gallons and 6,000 gallons at the same flow rate. Moreover, this synergistic effect occurred without significant filter breakage.

In addition, efficiency of metal removal in known processes is often inversely related to flow rate. The present invention allows increased efficiencies even at high flow rates. For instance, about 100 g. of zirconia purification material was tested in a static column, and was found to reduce arsenic levels from about 600 ppm to 1 ppb at a flow rate of 1 ml/min. However, when the flow rate increased, the efficiency of arsenic removal decreased. When the alumina purification material was used prior to the zirconia purification material, the efficiency of arsenic removal was improved even at the higher flow rates.

While not wishing to be bound by any theory, it is believed that the alumina may add a positive charge or cause redox reactions of metal species, such as arsenic, and impart charges to VOC molecules and bacteria, which causes them to become adsorbed onto the zirconia. For instance, it is known that arsenic can be oxidized from arsenate to arsenite in the presence of high concentrations of chlorine, and a similar effect may occur in the presence of the alumina purification material used in the invention. Heavy metal species that undergo similar changes in oxidation number under similar treatment conditions would also be removable by the process of the invention, and a determination of the specific operating parameters for such removal processes could be determined by optimization based upon the changes set forth herein.

The invention having been thus described with respect to its specific embodiments, it will be apparent to those of skill in the art that various modifications and adaptations of the invention can be made, and that various equivalents thereto exist. These are intended to be included by the appended claims, and by the scope of equivalents thereto.

What is claimed is:

1. A method for reducing contaminants in water, comprising:
contacting the water with a first purification medium comprising alumina; and
contacting the water with a second purification medium comprising zirconia.

2. The method of claim 1, wherein the water is contacted with the first purification medium, removed from the first purification medium, then contacted with the second purification medium, and removed from the second purification medium.

3. The method of claim 2, wherein the water removed from the second purification medium is purified potable water.

4. The method of claim 1, wherein the contaminants comprise heavy metals, halogenated organic compounds, bacteria, or a combination thereof.

5. The method of claim 4, wherein the bacteria comprise coliform bacteria, pseudomonal bacteria, or combinations thereof.

6. The method of claim 5, wherein the bacterial comprise E. coli, P. aeruginosa, or combinations thereof.

7. The method of claim 4, wherein the heavy metals comprise arsenic.

8. The method of claim 4, wherein the halogenated organic compounds comprise one or more halogenated hydrocarbons.

9. The method of claim 8, wherein the halogenated hydrocarbon comprises chloroform.

10. The method of claim 1, wherein the first purification medium comprises acid-washed alumina.

11. The method of claim 10, wherein the acid-washed alumina has a particle size in the range of about 24 mesh to about 48 mesh.

12. The method of claim 10, wherein the acid-washed alumina has an average particle size in the range of about 24 mesh to about 48 mesh.

13. The method of claim 10, wherein the acid-washed alumina has a BET surface area of about 160 to about 260 m²/g.

14. The method of claim 1, wherein the second purification medium comprises zirconia in a powdered form.

15. The method of claim 14, wherein the powdered zirconia has a particle size distribution ranging between about 5 to about 100 microns.

16. The method of claim 15, wherein the powdered zirconia has a particle size distribution ranging between about 10 and about 60 microns.

17. The method of claim 14, wherein the powdered zirconia has a mean particle size of about 40 microns or larger.

18. The method of claim 17, wherein the mean particle size is about 60 microns.

19. The method of claim 1, wherein the second purification medium comprises zirconia having pore sizes in the range from about 5 Angstroms to about 500 Angstroms.

20. The method of claim 19, wherein the pore sizes range from about 5 Angstroms to about 60 Angstroms.

21. The method of claim 1, wherein the second purification material comprises zirconia having a BET pore volume ranging from about 300 cm³/g to about 800 cm³/g.

22. The method of claim 21, wherein the BET pore volume ranges between about 300 cm³/g and about 600 cm³/g.

23. The method of claim 1, wherein the first purification medium comprises a mixture of an alumina, an aluminosilicate gel, and a silica gel.

24. The method of claim 1, wherein the second purification medium comprises granular zirconia.

25. The method of claim 24, wherein the granular zirconia has a particle size in the range of about 28 to about 100 mesh.

26. The method of claim 1, wherein the second purification medium comprises zirconia, activated carbon, and a binder therefor.

27. The method of claim 26, wherein the zirconia is present in an amount of about 5 wt % to about 15 wt %, the activated carbon is present in an amount of about 70 wt %, and the organic binder is present in an amount of 15 wt % to about 25 wt %, based on the total composition.
